(19) United States
(12) Patent Application Publication
(10) Pub. No.: US 2024/0392454 A1
(43) Pub. Date: Nov. 28, 2024

(54) SEPARATOR PLATE AND CELL FRAME FOR AN ELECTROCHEMICAL DEVICE

(71) Applicant: Reinz-Dichtungs-GmbH, Neu-Ulm (DE)

(72) Inventors: Andreas MICHALKE, Ulm (DE); Alexander TRIPPEL, Senden-Willenstetten (DE); Maxim VOVCUK, Neu-Ulm (DE); Andreas RUOPP, Merklingen (DE); Tobias WOLF, Neu-Ulm (DE); Hans WALDVOGEL, Krumbach (DE); Franz SCHWEIGGART, Pfaffenhofen (DE)

(21) Appl. No.: 18/674,575

(22) Filed: May 24, 2024

(30) Foreign Application Priority Data
May 25, 2023 (DE) 20 2023 102 898.5

(51) Int. Cl. C25B 13/02; C25B 13/05; C25B 13/08; H01M 8/0232; H01M 8/0239; H01M 8/0245; H01M 8/0258

(52) U.S. Cl. CPC C25B 13/02; C25B 13/05; C25B 13/08; H01M 8/0232; H01M 8/0239; H01M 8/0245; H01M 8/0258

(57) ABSTRACT

The present disclosure relates to a separator plate or cell frame for an electrochemical device, in particular for an electrolyzer or a fuel cell, having a first metallic layer with a first side and a second side opposite the first side, wherein the separator plate or the cell frame has at least one first through-opening for the supply of reaction medium and at least one second through-opening for the discharge of reaction medium, characterized in that the metallic layer has at least one first recess on the first side, which completely circumferentially encloses an inner space of the first recess, the inner space being completely filled with a first non-compressible material.

### CROSS REFERENCE TO RELATED APPLICATION

The present application claims priority to German Utility Model Application No. 20 2023 102 898.5, entitled “SEPARATOR PLATE AND CELL FRAME FOR AN ELECTROCHEMICAL DEVICE”, filed May 25, 2023. The entire content of the above-identified application is hereby incorporated by reference for all purposes.

### TECHNICAL FIELD

The present disclosure relates to a separator plate and a cell frame for an electrochemical device. Such electrochemical devices are, for example, electrolyzers and fuel cells.

### BACKGROUND AND SUMMARY

The prior art is described below using the example of an electrolyzer. Electrolyzers generate, for example, hydrogen and oxygen from water by applying an electrical potential and, if necessary, can simultaneously compress at least one of the gases generated, for example hydrogen. Conventional electrolyzers consist of a stack of electrochemical cells, each of which has a sequence of layers with a separator plate, a media diffusion structure, in particular a porous transport layer (PTL), a membrane electrode assembly (MEA) and a further media diffusion structure. The separator plate can be adjacent to a cell frame.

A stack of such electrochemical cells must be sealed off from the external environment, as the media inside the cells are pressurized above the environmental pressure. For this purpose, electrolyzers typically have a cell frame running around the outer edge of the electrochemical cell and the outer edge of the separator plate for each of the individual electrochemical cells that are stacked on top of each other to form an electrolyzer. The individual cells in the stack are pressed together, for example by means of screws extending between two end plates of the stack. The stack of electrochemical cells can have sealing elements running along the circumference between a cell frame and the separator plate or between a cell frame and the membrane electrode arrangement at an inward distance from the outer circumference.

The separator plate separates the media that are supplied from the media that are discharged. Furthermore, the electrical potential is applied to the electrochemical cell via the separator plate in order to carry out the electrolysis of a supplied medium, for example water.

To guide the media, the separator plates typically have through-openings to feed media into the space between the separator plate and the adjacent MEA and also channels that guide the medium fed in this way on the plate surface to a further through-opening in the separator plate, through which the medium is then discharged from the electrochemical cell. These channels are often embossed as parallel channels in the form of a flow field or active region on the surface of the separator plate. However, the separator plate can also be hydroformed or deep-drawn in order to mold the channel structures of the flow field into the separator plate. Consequently, the separator plate is usually formed during production using one of the above-mentioned processes.

In an electrolyzer, a pressure difference of more than 20 bar can occur between the external environment of the electrolyzer and the inside of the electrochemical cell. There can also be a large pressure difference across the MEA, for example water can be fed in as a reactant at a pressure of 2 bar, while hydrogen produced on the opposite side of the MEA is discharged from the unit cell at a pressure of 40 bar.

It is therefore important to seal off the flow field or the active region from the external environment and also from other compartments within the electrochemical system. For this purpose, sealing elements are usually provided around the individual through-openings for media in the separator plate as well as around the entire flow field or around the outer edge of the separator plate.

As an alternative to a separator plate, the cell frame can also be used to seal the individual cell from the external environment. For this purpose, appropriate sealing elements are molded and/or injection-molded into the cell frame. The cell frame can also be formed using the above-mentioned embossing, hydroforming or deep-drawing processes.

There are designs in which the cell frame area (cell frame, separator plate outside, and primarily the seal . . . ) is in the main line of force. As a result, the aforementioned elements of the cell frame area are subject to a certain settling behavior. This settling behavior is undesirable.

The present disclosure therefore sets itself the object of providing a separator plate and a cell frame for an electrochemical device, in which a secure seal between the individual layers of an electrochemical cell is possible, while at the same time reducing the settling behavior in the cell frame area, in particular of the seal operating in the direction of the main line of force.

This object is solved by the separator plate or the cell frame according to claim 1. Advantageous further developments of the cell frame or the separator plate according to the present disclosure are given in the dependent claims.

The separator plate or cell frame according to the present disclosure is intended for an electrochemical device such as an electrolyzer or a fuel cell. The separator plate or cell frame according to the present disclosure has a first metallic layer which has two flat sides, a first flat side and a second flat side opposite the first side.

In a conventional manner, the separator plate or the cell frame has a first through-opening and a second through-opening in the first metallic layer. The first through-opening is used to feed reaction medium and the second through-opening is used to discharge reaction medium. Further through-openings can be provided so that reactants and products of the electrochemical reaction can be fed in and discharged separately.

According to the present disclosure, the metallic layer has at least one first recess on its first side, which completely circumferentially encloses an inner space of the first recess. According to the present disclosure, the inner space of the first recess is completely filled with a first incompressible material.

An incompressible material is defined as a substance or material whose volume undergoes no or virtually no change when force or pressure is applied. Elastomers are generally considered incompressible. In contrast to an incompressible material, compressible materials are, for example, gases that can be compressed relatively easily.

As a typical incompressible material of the present disclosure an elastomer, in particular a fluororubber, FKM, and/or an ethylene-propylene-diene rubber, EPDM, can for example be used.

According to the present disclosure, the inner space is essentially completely filled with the first compressible material. This means that the inner space of the first recess is not merely partially filled. On the other hand, this also means that the incompressible material does not protrude significantly beyond the inner space.

Such a recess filled with an incompressible material is itself non-compressible and has a very high stiffness, higher than the stiffness of an unfilled recess and higher than the stiffness of an elastomer that is not within a recess. Such an element can therefore be used as a spacer and/or deformation limiter (stopper) to guide the area of this element in the main line of force when pressing a stack of individual cells. If such recesses with high rigidity according to the present disclosure are arranged in the vicinity of the active region, the active region itself is in a secondary line of force and is not significantly deformed when the stack of electrochemical cells is pressed together.

The essential feature of the present disclosure is that the recess is essentially completely filled with the incompressible material and this material does not find an escape space either perpendicular to the plane of the first metallic layer, or laterally, into which it could be pressed. The elastomers described above are therefore particularly suitable for the incompressible material.

By using an elastomer as filling for the first recess according to the present disclosure, it is possible to use the same material for filling the first recess as for adjacent sealing lips that are molded onto the separator plate or the cell frame. The filling of the first recess can therefore be carried out in the same step as the injection molding of elastomer sealing elements. Furthermore, since the creation of the first recess, for example by embossing, can take place in the same step as the embossing of channel structures in the active region, the spacer element according to the present disclosure can be produced with only a few or even without any additional production steps. This means that compared to the prior art, in which separate, additional elements are used for the function of the deformation limiter, production steps can be saved and no additional significant costs are incurred.

The essentially complete, or complete, filling with incompressible material refers in particular to the unassembled state as well as in particular to the assembled state. In the assembled state, particular care must be taken to ensure that no air space is created within the first recess, for example due to shrinkage of the incompressible material, and that the incompressible material is also completely within the first recess. Furthermore, the incompressible material should not protrude significantly beyond the first recess, especially not when the separator plate or cell frame is assembled or pressed.

The first recess can be arranged, in particular, in the edge area of the separator plate or the cell frame. This makes it possible to make better use of the separator plate or the cell frame, even with limited installation space. In particular, embossed recesses can be used as the first recess, especially on one of the corners of the separator plate or the cell frame or on one of their long sides. It is also advantageous if the first recesses are always arranged outside the active region, in particular in the area of the through-openings. However, it is also possible to place the first recess in the active region, so that the section of the active region surrounding this first recess is in a secondary force line of the pressing together of the stack of electrochemical cells.

A recess as described above can be provided not only on one of the sides of the separator plate or the cell frame, but also on both sides. Recesses on different sides of the first metallic layer can be arranged at a distance from or adjacent to each other in the plane of the first metallic layer. It is also possible to provide recesses arranged adjacent to each other on different layers with an opening between these recesses. This makes it possible to fill these recesses with the incompressible material together from one side of the first metallic layer. This can simplify the injection molding process for an elastomer, for example.

The first recess can take on different shapes, for example an elongated structure such as a bead or groove or a round structure such as a cup.

As already described, the incompressible material essentially does not protrude beyond the respective recess in the uncompressed state and/or in the compressed state. This means in particular that a protrusion of the incompressible material in the uncompressed state and/or in the compressed state is no more than 5%, advantageously no more than 3% of the maximum depth of the inner space of the recess. Advantageously, there is no protrusion at all over the inner space of the recess parallel to the plane of the first metallic layer.

That the incompressible material substantially completely fills the inner space of a recess means in practice in particular that the incompressible material is not below by more than 5%, advantageously not more than 3%, of the maximum depth of the inner space of the recess, a line extending between the two edges of the recess or the plane of the first metallic layer that passes through the outermost edge of the recess. Advantageously, the incompressible material is not below the aforementioned line at any point.

Insofar as the present disclosure relates to a separator plate, this can furthermore have an active region (also called flow field) to which reaction medium is fed by means of the first through-opening and from which reaction products are discharged via a second through-opening. The active region advantageously has at least one set of flow channels introduced into the first metallic layer. The flow channels can essentially run parallel to each other. The introduction of the set of flow channels is advantageously carried out by an embossing process.

Some examples of separator plates and cell frames according to the present disclosure are given below. The same and similar reference signs denote the same and similar elements, so that their explanation is not repeated if not necessary. Furthermore, the following examples show a plurality of essential features and a plurality of optional features of the present disclosure in combination. However, it is possible that individual optional features of the following examples can also be used independently of further optional features of the respective example for the further development of the present disclosure. In the same way, it is also possible to combine optional features of one example with optional features of other examples independently of other optional features of the respective examples.

In the figures:

### BRIEF DESCRIPTION OF THE FIGURES

FIGS. 1, 2, 3A, 3B, 4A, 4B, 5A, 5B, 6, 7A, 7B, 7C, and 7D show a separator plate according to the present disclosure in different views and sections.

FIG. 8 shows the force-distance-curve of different structures of a separator plate.

FIGS. 9A, 9B, 9C, 9D, and 9E show a further separator plate according to the present disclosure in different views and sections.

FIG. 10 shows a cell frame according to the present disclosure.

### DETAILED DESCRIPTION

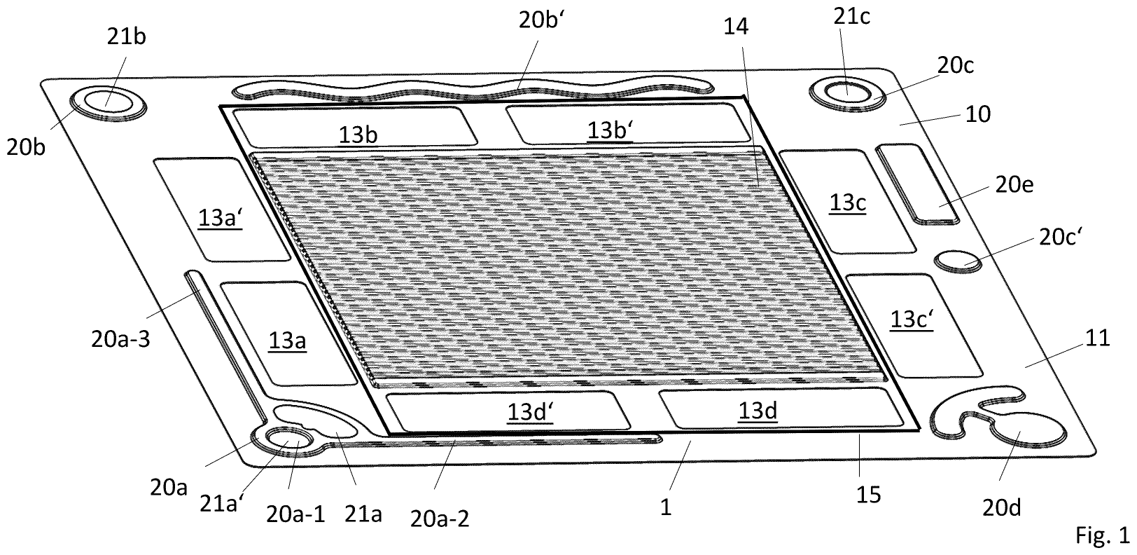

FIG. 1 shows a separator plate 1 in oblique view. The separator plate 1 has a metallic layer 10. In principle, separator plates can also have several metallic layers, but single-layer separator plates are common in electrolyzers, as in this example. By way of example, different contours of rigid elements 20a, 20a-1, 20a-2, 20a-3, 20b, 20b′, 20c, 20c′, 20d, and 20e according to the present disclosure can be seen in the separator plate in FIG. 1.

The metallic layer 1 has a first flat side 11 and, opposite, a second flat side 12 of the metallic layer 10, where FIG. 1 shows a top view of the first side 11 of the metallic layer 10. The metallic layer 10 has a plurality of through-openings 13a, 13a′, 13b, 13b′, 13c, 13c′, 13d, and 13d′, which are used to feed or discharge reactant and products of the electrochemical device, in this case an electrolyzer. An active region is arranged between the through openings 13a, 13a′, 13b, 13b′, 13c, 13c′, 13d, and 13d′ as a flow area 14, which has a set of parallel, embossed flow channels for reactants or products. Since the channels of the active region 14 were formed in the metallic layer 10 by an embossing process, longitudinal channels are formed on both sides 11 and 12 of the metallic layer 10. The channels on one side are used to pass through the reactant, in this case water, and discharge the reaction product oxygen, while the channels on the second side of the metallic layer 10 are used to discharge the reaction product hydrogen.

Furthermore, rigid elements 20a, 20a-1, 20a-2, 20a-3, 20b, 20b′, 20c, 20c′, 20d, and 20e according to the present disclosure are arranged in the metallic layer 10, which are described in more detail in the following Figures. The seal 15, the deformation of which is limited by the rigid elements 20a, 20a-1, 20a-2, 20a-3, 20b, 20b′, 20c, 20c′, 20d, and 20e, is shown here schematically and seals the through openings 13b, 13b′, 13d, 13d′ (in this example these are hydrogen ports) and the active region 14 from the rest of the separator plate.

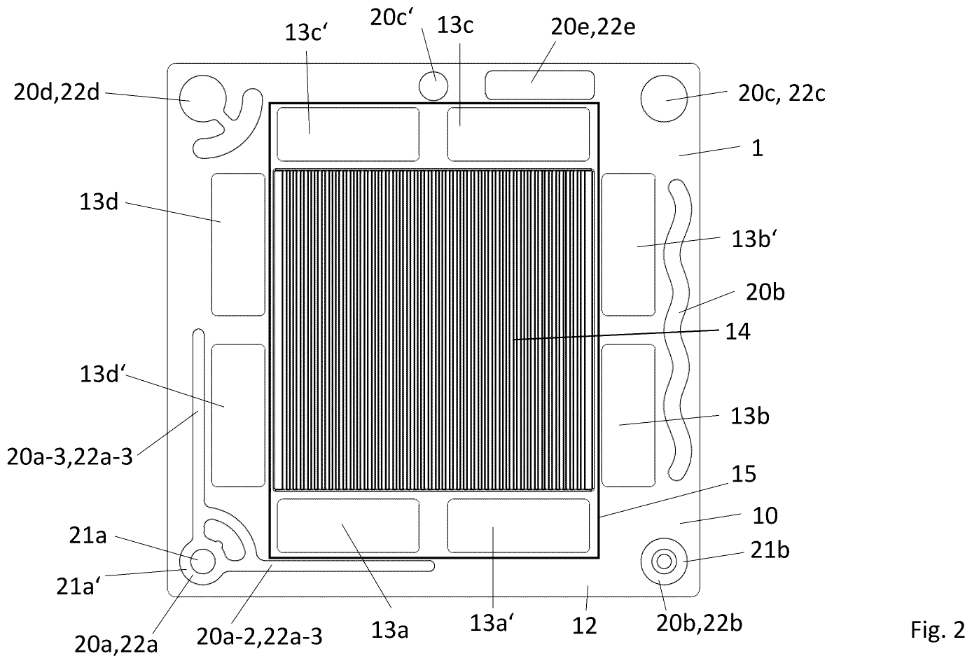

FIG. 2 shows the separator plate 1 from FIG. 1 in plan view of the second side 12 of the metallic layer 10 of the separator plate 1. The individual elements 20a, 20a-1, 20a-2, 20a-3, 20b, 20b′, 20c, 20c′, 20d, and 20e correspond to those in FIG. 1 and are explained further in the following Figures. The embossed structures of the separator plate 1 each contain a precisely fitting elastomer filling according to the present disclosure. FIG. 2 also schematically shows a seal 15, which in the case of FIG. 2 seals the water ports 13a, 13a′, 13c and 13c′.

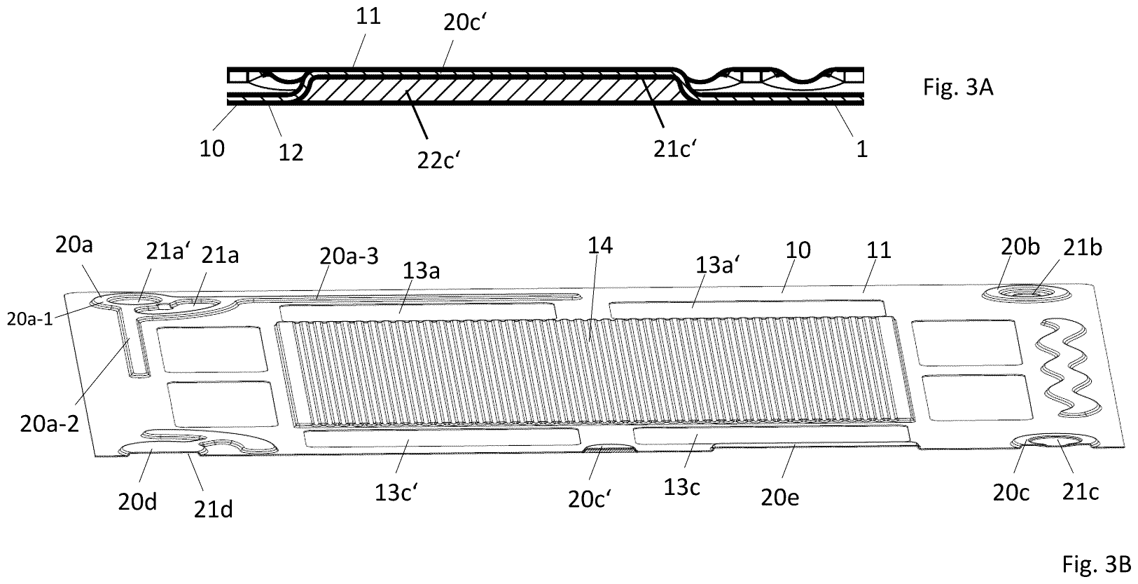

FIG. 3A shows a section through the spacer element 20c′ in FIG. 2. FIG. 3B shows the same section in top view through the separator plate 1 of FIG. 2. The section in FIG. 3A is an excerpt from the section in FIG. 3B in the area of the deformation limiter 20c′, the shape of which is a simple embossed cup.

The deformation limiter 20c′ has a recess 21c′ in the metallic layer 10 as seen from the second side 12 of the first metallic layer 10. This recess 21c′ is completely closed all the way around, i.e. in the plane of the metallic layer 10 or parallel to it, the edge of the recess 21c′ runs completely around the recess 21c′ and is a closed loop. The recess 21c′ is completely filled with an elastomer 22c′. The elastomer 22c′ fills the recess 21c′ up to the plane of the surface 12 of the metallic layer 10 without protruding beyond this plane. A recess 21c′ filled in this way has a high rigidity, provided that the material 22c′ filled into the recess 21c′ is essentially incompressible. For example, an elastomer is suitable here as the filling material 22c′. This elastomer shown here and in the further drawings by way of example is a fluoropolymer. This filling material 22c′, which is essentially incompressible, cannot move out of the recess 21c′ in any direction when the separator layer 1 is compressed and therefore stiffens the recess 21c′. The recess 21c′ thus forms a stopper or deformation limiter, so that when the separator layer 1 is compressed in a stack of electrochemical cells, this stopper is located in the main line of force, while the active region 14 is only arranged in a secondary line of force and consequently does not undergo any significant deformation. As a result, the channels of the active region 14 are not significantly deformed and can therefore fulfill their task of guiding the reactants and products of the electrochemical reaction in the electrochemical cell. In FIG. 3B, only the recess 21c′ together with the filling 22c is to be regarded as a deformation limiter according to the present disclosure; the embossed structures 20d and 20c, which are cut in the foreground of FIG. 3B, are unfilled (not filled with elastomer) and thus easily deformable.

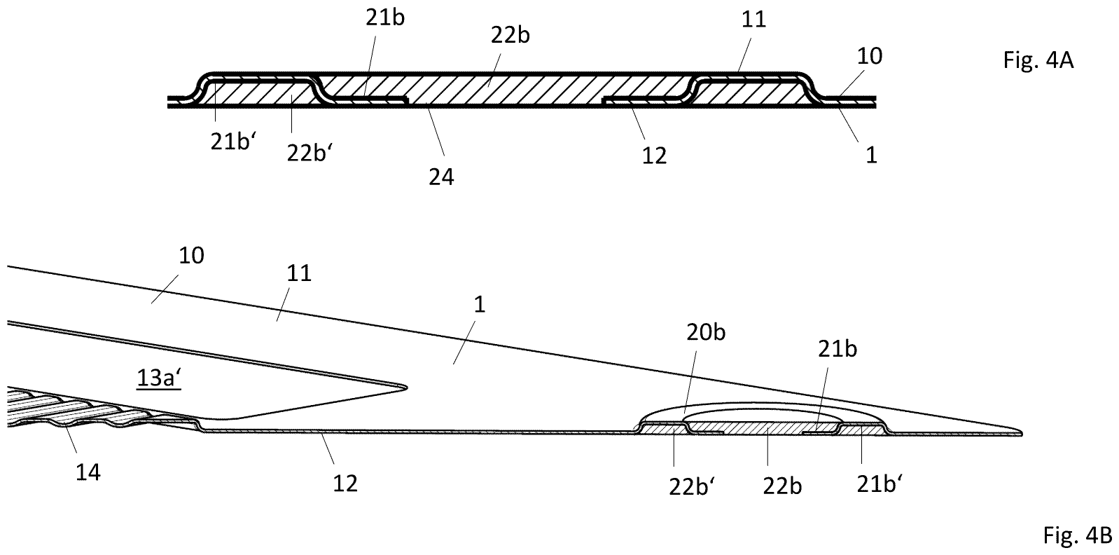

Similar to the illustrations in FIGS. 3A and 3B, FIGS. 4A and 4B show sections through the metallic layer 10 in FIG. 2 in the area of element 20b. FIG. 4A again shows a cross-section in detail and FIG. 4B a cross-section in oblique view.

The section of FIG. 4A shows the element 20b, which has a recess 21b on the first side 11 of the metallic layer and a recess 21b′ running around this recess 21b on the second side 12 of the metallic layer 10. This recess 21b′ is circular in shape and includes a central area which is not recessed when viewed from the second side 12 and which is formed as recess 21b when viewed from the first side 11. The recess 21b is open on both sides of the metallic layer 10, in that the metallic layer 10 is perforated in the region of this recess 21b by means of a through-opening 24. Both recesses, the recess 21b′ viewed from the second side 12 and the recess 21b enclosed therein viewed from the first side 11, are filled with the same elastomeric material 22b′, 22b. The through-opening 24 makes it possible to fill both cavities 21b and 21b′ with elastomer in the same injection process, as the elastomer can flow through a channel (not shown here because it is not in the section plane) from recess 21b to recess 21b′ or vice versa. An essential aspect of the present disclosure is that the recesses 21b and 21b′ are each closed on the circumferential side, so that the elastomer 22b or 22b′ cannot escape laterally in the plane of the metallic layer 10. Furthermore, the material 22b and 22b′ does not protrude beyond the metallic layer 10, but does not lie below the respective recess adjacent to the layer surface.

After pressing the metallic layer 10 in a stack of electrochemical cells for producing an electrolyzer, the respective elastomer 22b or 22b′ is enclosed between adjacent layers, i.e. between the metallic layer 10 and one of the layers adjacent thereto or between adjacent layers which enclose the metallic layer 10 between them. This gives the embossed structures 20b and 20b′ a very high rigidity and they can act as deformation limiters in the main line of force of the compression of the cell stack.

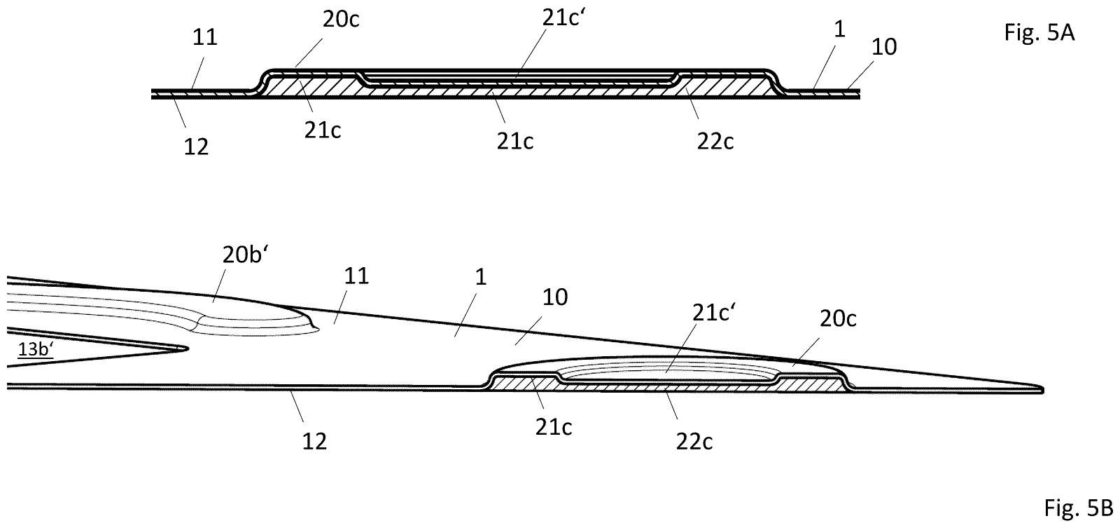

FIGS. 5A and 5B show sections in cross-section or in oblique view through the metallic layer 10 in the area of the element 20c in a similar way to FIGS. 3A, 3B, 4A, and 4B. Viewed from the second side 12, the element 20c has a recess 21c that extends over the entire element 20c. The recess has a less deep central area, in which a recess 21c′ is formed in the metallic layer 10 as seen from the first side 11 of the metallic layer 10. The depth of the recess 21c′ is less than the depth of the recess 21c, so that the recess 21c also extends continuously over the recess 21c′ on the second side 12 of the metallic layer 10 and can be filled with an elastomer 22c. This elastomer 22c stiffens the metallic layer 10 in the area of the recess 21c in an area that runs around the recess 21c′. The recess 21c in this circumferential area therefore forms a deformation limiter when the metallic layer 10 is pressed into a stack of electrochemical cells. On the other hand, the recess 21c′ can serve as a centering aid for adjacent components.

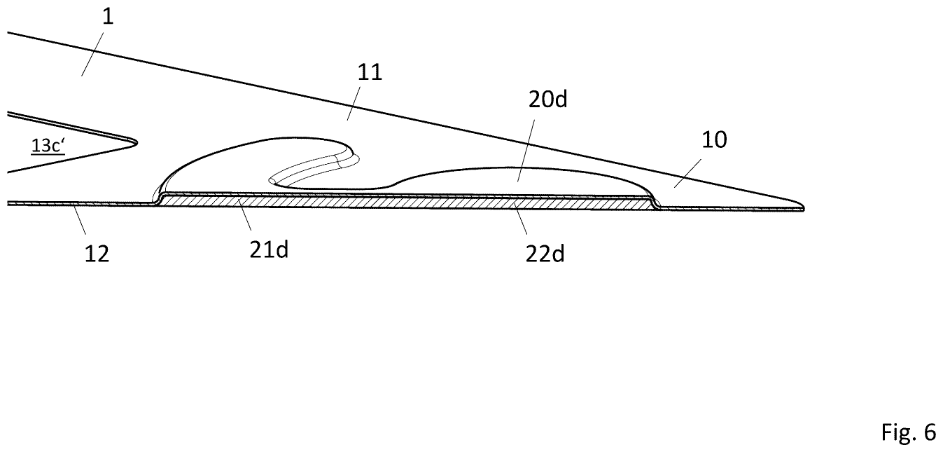

FIG. 6 shows a section through the recess 21d in FIG. 2 in a similar way to FIGS. 3A, 3B, 4A, 4B, 5A, and 5B. This recess 21d extends from the second side 12 of the metallic layer 10 and is filled by an elastomer 22d. The elastomer 22d completely fills the recess 21d without, however, protruding beyond the recess 21d in the direction of the second side 12. This means that the filling 22d with elastomer neither lies below the plane of the surface 12 nor protrudes beyond the plane of the surface 12 adjacent to the recess 21d.

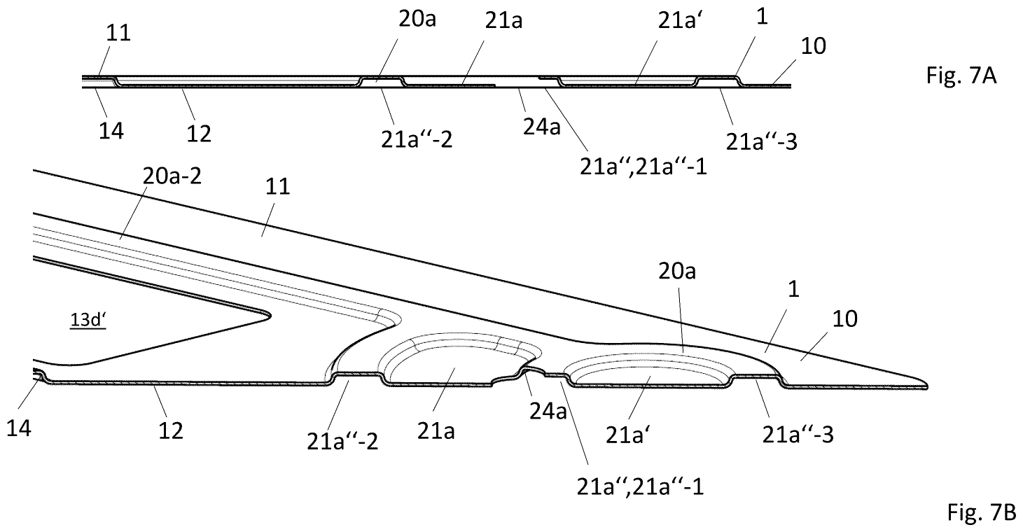

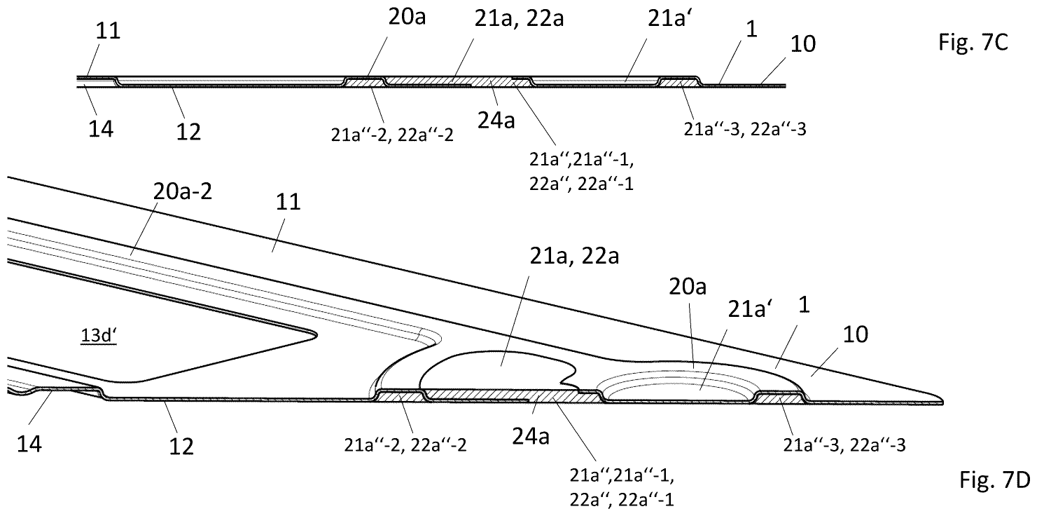

FIGS. 7A, 7B, 7C, and 7D show sections through the metallic layer 10 in the area of the recesses 21a and 21a′ in FIG. 2. The recesses 21a and 21a′ extend from the side 11 of the metallic layer 10 in the direction of the second side 12 of the metallic layer 10. They are surrounded by a recess 21a″, which extends from the second side 12 into the metallic layer 10. In the plane or parallel to the plane, the recess 21a″ extends not only in a central area 21a″-1 but also laterally as areas 20a-2 and 20a-3 along the two outer edges of the metallic layer 10, which extend at right angles to each other. As can be seen in FIG. 7A, the two recesses 21a and 21a″ are connected to each other via a through-opening 24a in the metallic layer 10.

FIGS. 7A and 7B show the metallic layer without any elastomer filling. FIGS. 7C and 7D show the same sections as in FIGS. 7A and 7B, the recess 21a″ now being filled with an elastomer 22a″. Furthermore, the recesses 21a and 21a″, which are connected via an opening 24a, are also filled with the same elastomer 22a. The complete filling of the recesses 21a, 21a′ and 21a″ according to the present disclosure leads to a high rigidity of the layer 10 in the region of these recesses, so that the recesses serve as a deformation limiter or spacer element due to their being filled with elastomer when the layer 10 is pressed in a stack of electrochemical cells. As a result, the areas of the metallic layer 10 with the recesses 21a, 21a′, 21a″ are in the main line of force of the compression and thus relieve the flow area 14, which is only in a secondary line of force.

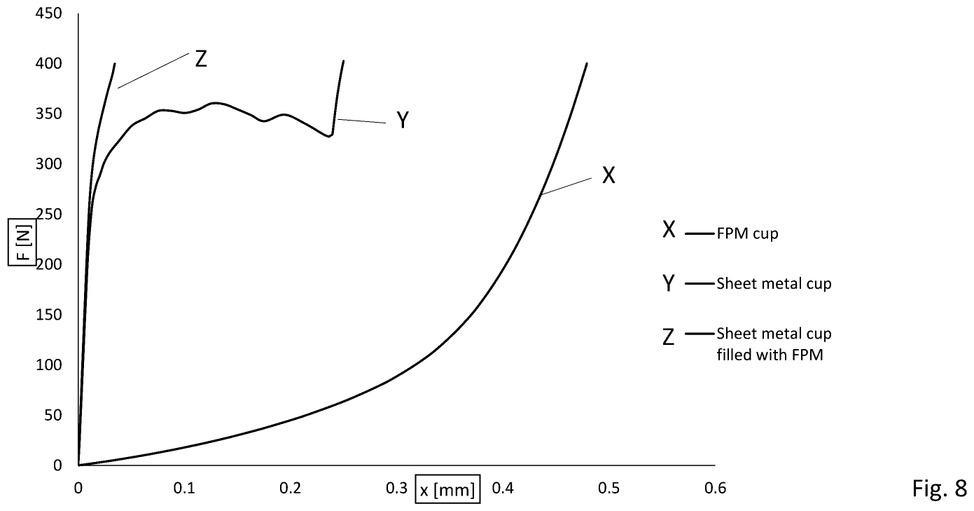

FIG. 8 shows a force-displacement diagram for different structures in a metallic layer 10 of a separator plate 1. X shows the force-displacement diagram of a structure that consists only of an elastomer bead. A fluoropolymer was used as the elastomer here and in the following. Y in FIG. 8 shows the force-displacement diagram of a sheet metal cup, i.e. a bead embossed into the metallic layer 10. The bead has the same width as the FPM cup of curve X. Z shows the force-displacement diagram of a sheet metal cup as used for curve Y, but the sheet metal cup is filled with the FPM elastomer of curve X. Curve Z shows a considerably higher stiffness up to very high forces, while curves Y and X show only low stiffnesses or, in curve Y, only a high initial stiffness. The recess according to the present disclosure, which is filled with an incompressible material, such as an FPM elastomer in this case, therefore has a very high rigidity and can therefore serve as a deformation limiter.

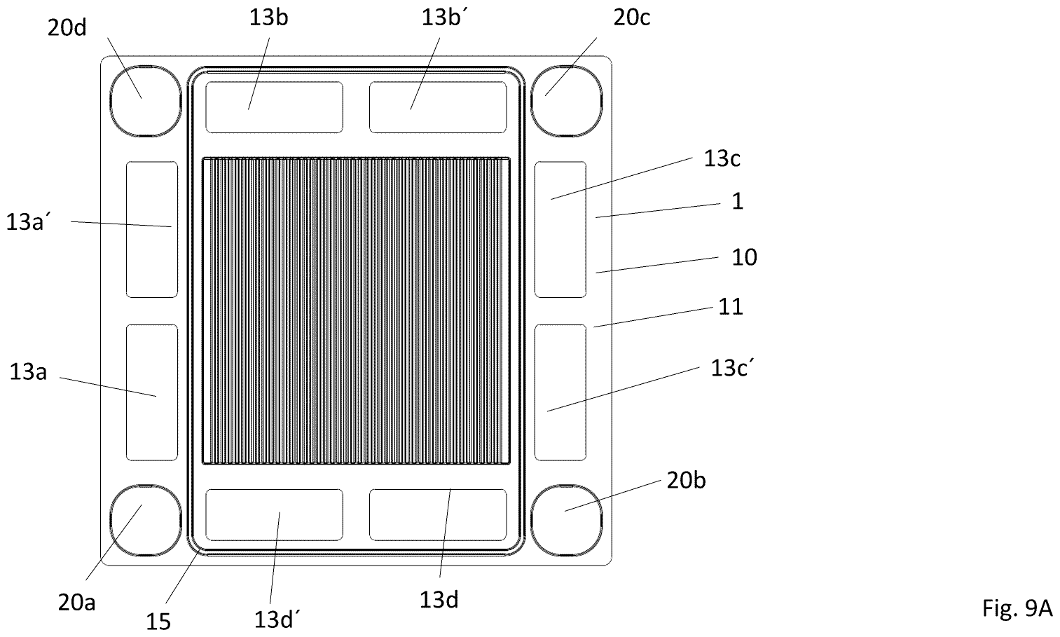

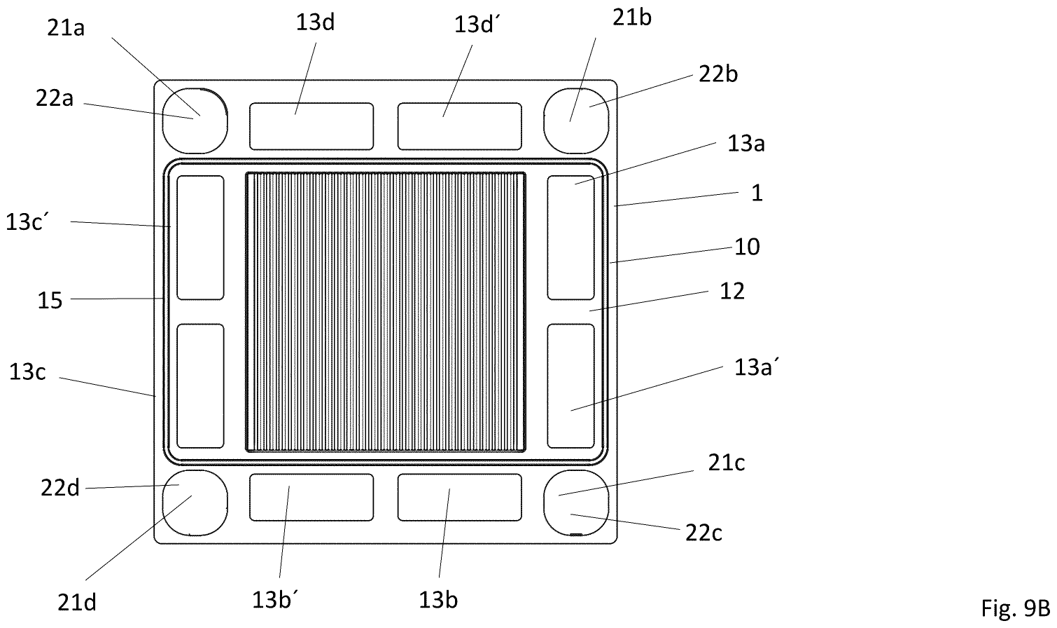

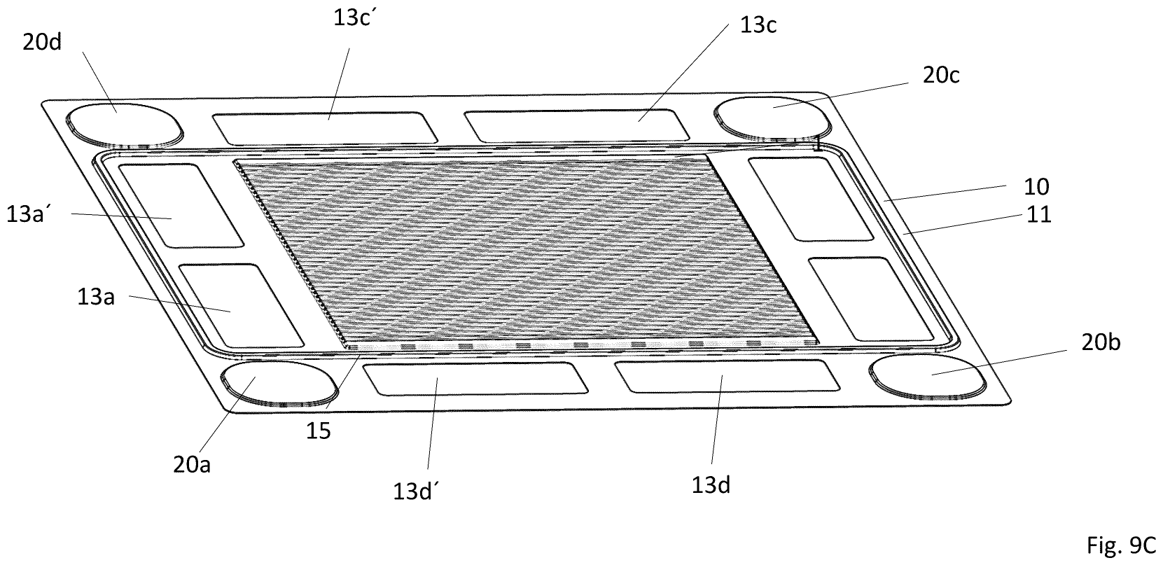

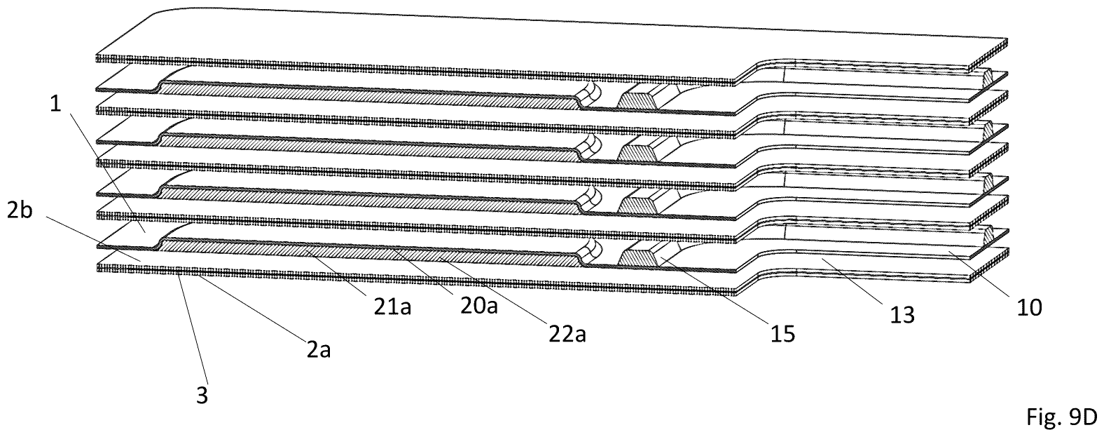

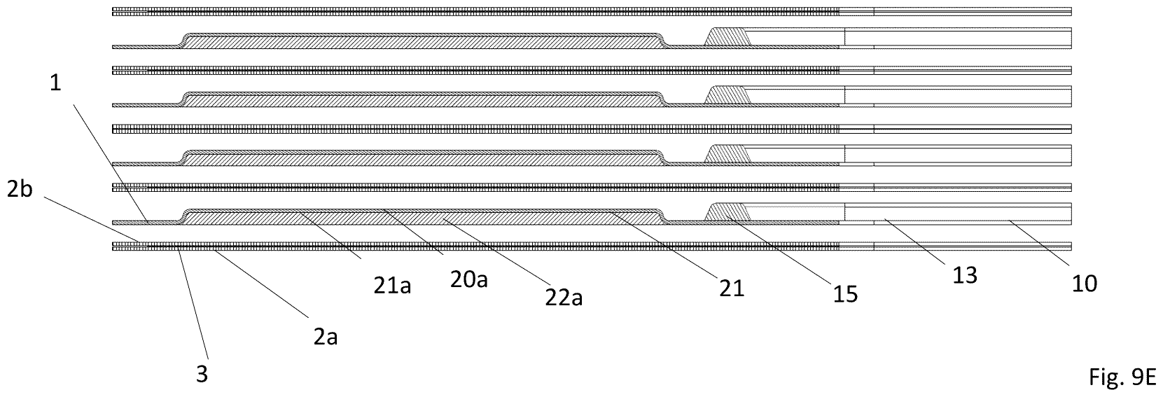

FIG. 9A shows a top view of another separator plate 1 according to the present disclosure on the upper side 11 of its metallic layer 10. The separator plate 1 has through-openings 13a, 13a′, 13b, 13b′, 13c, 13c′, 13d, 13d′ for the supply and discharge of reactants and products of an electrochemical reaction. The through-openings 13b, 13b′, 13d and 13d′, which serve as ports for the supply and discharge of water and oxygen, are sealed by a sealing line 15 made of a sealing material, for example an elastomer. In the 4 corners of the essentially square metallic layer 10 there are embossed structures 20a, 20b, 20c and 20d, which rise out of the plane of the drawing in the direction of the observer.

FIG. 9B shows the same separator plate as FIG. 9A, but now from below, i.e. as seen from the side 12 of the metallic layer 10. There is also a sealing line 15 on this side, which surrounds the ports 13a, 13a′, 13c and 13c′ and seals these ports. These ports are used, among other things, to supply or discharge hydrogen. The embossed structures 20a, 20b, 20c and 20d from FIG. 9A can be seen here on side 12 as recesses 21a, 21b, 21c and 21d and are completely filled with elastomer 22a, 22b, 22c and 22d, whereby completely filled recesses in accordance with the present disclosure are present in the corners of the separator plate 1.

FIG. 9C shows the same separator plate according to the present disclosure as in FIG. 9A, but now in oblique view and top view of the side 11 of the metallic layer 10.

FIG. 9D shows a further section through the recess 21a and the port 13a of the separator plate 1 in FIG. 9A or 9C in top view and in section. The separator plate 1 is shown in FIG. 9D as a stack of identical separator plates, with an anode-side cell frame 2a, a cathode-side cell frame 2b and a membrane electrode assembly (MEA) 3 arranged between each two adjacent separator plates. Such a stack forms part of an electrochemical device, for example an electrolyzer.

FIG. 9E shows the same section as FIG. 9D, but in cross-section.

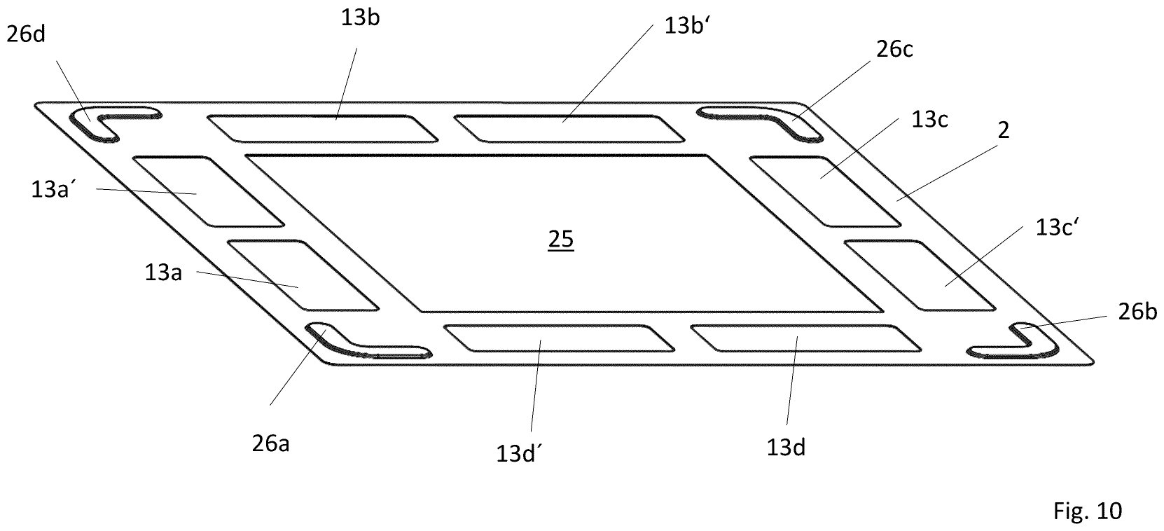

FIG. 10 shows a cell frame 2. The cell frame 2 has a central opening 25, which is surrounded by the ports 13a, 13a′, 13b, 13b′, 13c, 13c′, 13d and 13d′. In contrast to the separator plates 1 of FIGS. 9A to 9C, the cell frame 2 has no sealing lines, but has recesses 26a, 26b, 26c and 26d in the corners of the substantially rectangular cell frame 2 in accordance with the present disclosure, which serve as deformation limiters for sealing lines in adjacent layers or components. Such cell frames 2 together with a separator plate form part of an electrochemical cell, which in turn can be arranged in a stack of electrochemical cells to form an electrochemical device.

1. A separator plate or cell frame for an electrochemical device having a first metallic layer with a first side and a second side opposite the first side,
wherein the separator plate or the cell frame has at least one first through-opening for supply of reaction medium and at least one second through-opening for discharge of reaction medium,
wherein the first metallic layer has at least one first recess on the first side, which completely circumferentially encloses an inner space of the first recess, the inner space being completely filled with a first non-compressible material.

2. The separator plate or cell frame according to claim 1, wherein the first metallic layer has a second recess on the second side, which completely circumferentially encloses an inner space of the second recess, the inner space being completely filled with the first non-compressible material.

3. The separator plate or cell frame according to claim 2, wherein two recesses are arranged adjacent to one another in a plane of the first metallic layer.

4. The separator plate according to claim 3, wherein the first metallic layer in the first recess and/or in the second recess and/or between the first recess and the second recess has a through-opening between the first side and the second side.

5. The separator plate or cell frame according to claim 1, wherein the first non-compressible material contains or consists of an elastomer.

6. The separator plate or cell frame according to claim 1, wherein the first non-compressible material in the at least one first recess does not substantially protrude beyond the inner space of the at least one first recess in an uncompressed state and/or in a compressed state.

7. The separator plate or cell frame according to claim 6, wherein the first non-compressible material in the at least one first recess does not protrude beyond the inner space of the at least one first recess by more than 5% of a maximum depth of the inner space in the uncompressed state and/or in the compressed state.

8. The separator plate or cell frame according to claim 1, wherein the first non-compressible material in the at least one first recess in an uncompressed state and/or in a compressed state is not below a maximum depth of the inner space of the first recess by more than 5%, a connecting line extending between two edges of the at least one first recess within the inner space of the at least one first recess.

9. The separator plate or cell frame according to claim 1, wherein on the first side and/or on the second side one or more at least one first recesses are arranged at one or more corners of the separator plate or of the cell frame and/or are arranged at least partially circumferentially around one or more of the first through-opening or the second through-opening and/or are arranged at least partially circumferentially around an active region and/or are arranged at least partially circumferentially around all embossed structures of the first metallic layer, or are arranged in a combination thereof.

10. The separator plate or cell frame according to claim 1, wherein the at least one first recess has an elongate shape and/or a round shape and/or a free form when viewed from above a plane of the first metallic layer.

11. The separator plate or cell frame according to claim 1, wherein the separator plate has an active region, wherein the first through-opening is configured to feed reaction medium to the active region, and the second through-opening is configured to discharge reaction products from the active region.

12. The separator plate or cell frame according to claim 11, wherein the active region has at least one set of flow channels embossed in the first metallic layer.

13. The separator plate or cell frame according to claim 5, wherein the elastomer comprises fluororubber (FKM) and/or ethylene-propylene-diene rubber (EPDM).

14. The separator plate or cell frame according to claim 7, wherein the first non-compressible material in the at least one first recess does not protrude beyond the inner space of the at least one first recess by more than 3% of the maximum depth of the inner space in the uncompressed state and/or in the compressed state.

15. The separator plate or cell frame according to claim 7, wherein the first non-compressible material in the at least one first recess does not protrude at all beyond the inner space of the at least one first recess in the uncompressed state and/or in the compressed state.

16. The separator plate or cell frame according to claim 8, wherein the first non-compressible material in the at least one first recess in the uncompressed state and/or in the compressed state is not below the maximum depth of the inner space of the at least one first recess by more than 3%, the connecting line extending between the two edges of the at least one first recess within the inner space of the at least one first recess.

17. The separator plate or cell frame according to claim 10, wherein the at least one first recess is shaped as a bead.

18. The separator plate or cell frame according to claim 10, wherein the at least one first recess is shaped as a cup.
